(19) United States
(12) Patent Application Publication
(10) Pub. No.: US 2008/0113100 A1
(43) Pub. Date: May 15, 2008

(54) Method And Apparatus For Producing Coated Molded Product

(75) Inventor: Takao Umezawa, Gunma (JP)

Correspondence Address: OLIFF & BERRIDGE, PLC, P.O. BOX 320850, ALEXANDRIA, VA, 22320-4850, US

(73) Assignee: OSHIMA ELECTRIC WORKS CO., LTD., Ota-Shi (JP)

(21) Appl. No.: 11/795,014

(22) PCT Filed: Jan. 13, 2006
(86) PCT No.: PCT/JP2006/300362

§ 371 Date: Jul. 10, 2007

(30) Foreign Application Priority Data
Jan. 14, 2005 (JP) 2005-007762

(51) Int. Cl. B05D 7/00; B29C 45/00; B29C 45/16; B29C 45/76

(52) U.S. Cl. 427/296; 264/328.1; 264/255; 427/412.1; 425/90; 425/91; 425/135; 425/542; 118/50

(57) ABSTRACT

A hollow coated molded product is easily produced whose interior is coated, by using first and second moldings injection-molded through a first injecting step. Against first and second moldings injection-molded through a first injecting step, a coating device provided on a robot hand is butted and forms coatings thereon at a step at which a movable mold is separated from the fixed mold and thereafter, the first and second moldings are butted against each other and integrated through a second injecting step, whereby a coated molded product is formed.

### CROSS-REFERENCE TO RELATED APPLICATION

This application is the U.S. National Stage of PCT/JP2006/300362, filed Jan. 13, 2006, which claims priority from JP2005-007762, filed Jan. 14, 2005, the entire disclosures of which are incorporated herein by reference thereto.

### BACKGROUND

The present disclosure relates to a method and apparatus for producing a coated molding.

Generally, coated molded products, such as an emblem of a vehicle, for example, have been improved in design by coating a surface with a material that has a coloring or reflecting effect. In an exemplary method for producing this, the member surface is coated with a decorative chromium plating coating (for example, refer to Japanese Published Unexamined Patent Application No. 6-146069).

Recently, hexavalent chrome, used for plating, has been found to be harmful to humans and causes environmental pollution concerns due to its environmental contamination. As a result, it is subjected to regulation, creating a demand for a plating free from chrome.

As a remedial measure, it is suggested that on a base material surface, coating is formed by a deposition system for vacuum evaporation or sputtering, and the surface of the coating is further coated by a resin material (for example, refer to Japanese Published Unexamined Patent Application No. 6-169191).

In the method suggested by the prior art, after the base material is taken out from an injection-molding device, it is set in a vacuum evaporation system and coated. Then, the coated base material is taken out from the vacuum evaporation system and set in the injection-molding device where a resin material is injection-molded on the coated surface. In the method suggested in the prior art, there are a large number of steps and these steps take a great deal of time, with a low working efficiency. The surfaces to be coated may be flawed, covered with dust, touched by hands, or contaminated with oil in the taking-out step, setting step, or conveyance step from one device to another. Due to these potential problems, a satisfactory coated product cannot be obtained resulting in a deteriorated production yield. These are amongst the problems to be addressed by the present invention.

### SUMMARY

In view of the above-described circumstances, the present invention was made to solve the above-described problems. An exemplary aspect of the invention includes a method for producing a coated molded product including: an injection-molding device including first and second molds that are constructed to move relative to each other so as to separate from and come into contact with each other at least in opposite directions of mold surfaces that form a molding, and an injecting device that performs injection-molding; and a coating device that coats the molding and a moving device that moves the coating device, the method comprising: injection-molding the molding by the injecting device after butting the mold surfaces against each other; demolding the molded molding after separating the molds from each other in a state that the molding is supported on the first mold; forming a coating on the molding by the coating device after moving the coating device so as to butt against the molding supported on the first mold in the state that the molds are separated from each other; and separating the coating device from the coated molding.

An exemplary aspect of the invention includes a method for producing a coated molded product including: an injection-molding device including first and second molds that are constructed to move relative to each other so as to separate from and come into contact with each other at least in opposite directions of mold surfaces and have the mold surfaces that form a molding, an injecting device that performs injection-molding, and a moving device that moves the molding; a coating device that coats the molding, the method comprising: injection-molding a molding by the injecting device after butting the mold surfaces against each other; demolding the molded molding after separating the molds from each other in a state that the molding is supported on the first mold; butting the molding supported on the first mold against the coating device after being demolded from the molds; forming a coating on the butted molding; and separating the coated molding from the coating device.

An exemplary aspect of the invention includes a method for producing a coated molded product including: an injection-molding device including first and second molds that are constructed to move relative to each other so as to separate from and come into contact with each other in opposite directions of mold surfaces and move parallel to each other along the surface direction and have mold surfaces that forms first and second moldings, respectively, and an injecting device that performs injection-molding; and a coating device that coats at least one of the moldings and a moving device that moves the coating device, the method comprising: injection-molding first and second moldings after butting the mold surfaces against each other; demolding after separating the molds from each other in a state that the first molding is supported on the first mold and the second molding is supported on the second mold; moving the coating device so as to butt against at least one of the demolded moldings and forming a coating on the butted molding to form a coated molding; and injection-molding to bond the first and second moldings together after butting the first mold and second mold against each other so as to butt the coated molding and the other molding against each other.

An exemplary aspect of the invention includes a method for producing a coated molded product including: an injection-molding device including first and second molds that are constructed to move relative to each other so as to separate from and come into contact with each other in opposite directions of mold surfaces and move parallel to each other, and have the mold surfaces that form first and second moldings, respectively, an injecting device that performs injection-molding, and a moving device that moves the moldings; and a coating device that coats the moldings, the method comprising: injection-molding first and second moldings after butting the mold surfaces against each other, the mold surfaces for molding the first and second moldings formed on both molds; demolding the molded first and second moldings after separating the molds from each other in a state that the molded first and second moldings are supported on at least one of the molds; moving the coating device so as to butt against at least one of the demolded moldings; forming a coated molding by forming a coating on the butted molding; and injection-molding to bond the first and second moldings together after moving the coated molding so as to place it into a mold on the side facing the other molding, and butting the first mold and the second mold so that the coated molding and the other molding butt against each other.

According to an exemplary aspect of the invention, the coating device is a vacuum evaporation system.

According to an exemplary aspect of the invention, a coating is formed on a surface that is exposed due to separating molds from each other.

According to an exemplary aspect of the invention, the surface on which a coating is formed is a part of an exposed surface, and the coating on this part is performed by covering a portion that is not to be coated by a masking provided by the coating device.

According to an exemplary aspect of the invention, the surface on which the coating is formed is a part of an exposed surface exposed due to separating molds from each other, and coating on this part is performed by butting the coating device against it after covering a portion that is not to be coated by a masking detachably provided by the moving device.

According to an exemplary aspect of the invention, a surface on which the coating is formed is a surface exposed due to demolding from the molds by the moving device.

According to an exemplary aspect of the invention, a surface on which coating is formed is a part of an exposed surface, and coating on the part is performed by covering a portion that is not to be coated by a masking provided by the coating device.

According to an exemplary aspect of the invention, the coating step is performed a plurality of times by a plurality of coating devices provided movably in the moving device.

According to an exemplary aspect of the invention, the coating step is performed a plurality of times by the coating device provided, respectively, in a plurality of moving devices.

According to an exemplary aspect of the invention, on the first and second molds, mold surfaces for molding a plurality of moldings are formed respectively, and the coating step is for coating at least one of the plurality of moldings molded through the injecting step.

According to an exemplary aspect of the invention, when a plurality of moldings are coated, coatings on the plurality of moldings are the same.

According to an exemplary aspect of the invention, when a plurality of moldings are coated, coatings on the plurality of moldings are different from each other.

According to an exemplary aspect of the invention, the coating device comprises a plurality of coating devices provided movably in the moving device, or a coating device provided in a plurality of moving devices respectively, the coating step is performed for the molding molded through the injecting step by at least one coating device selected among the plurality of coating devices.

According to an exemplary aspect of the invention, coatings to be formed on moldings by a plurality of coating devices are different between a previous molding and a current molding.

According to an exemplary aspect of the invention, a plurality of coatings are different in coating position from each other.

According to an exemplary aspect of the invention, a coating is formed on one of the first and second moldings.

According to an exemplary aspect of the invention, a coating is formed on both first and second moldings.

According to an exemplary aspect of the invention, a coating is formed on both first and second moldings, and coatings on the first and second moldings are formed by successively moving the coating device.

According to an exemplary aspect of the invention, the coating is formed on both first and second moldings, and coatings on the first and second moldings are formed by successively moving the moldings by the moving device.

According to an exemplary aspect of the invention, coatings on both moldings are formed by individual coating devices provided for the respective moldings.

According to an exemplary aspect of the invention, the moving device is a manipulator.

An exemplary aspect of the invention includes an apparatus for producing a coated molded product comprising: an injection-molding device including first and second molds that are constructed to move relative to each other so as to separate from and come into contact with each other in opposite directions of mold surfaces that form a molding, and an injecting device that performs injection-molding; a coating device that coats a molding and a moving device that moves the coating device; and a controller that outputs operation control instructions to the injection-molding device and coating device, wherein the controller is constructed so as to output to the injection-molding device: a butting instruction to butt mold surfaces against each other, the mold surfaces being formed on both molds, and an injecting instruction for injection-molding a molding to the injecting device in the butted state; and a demolding instruction to demold by separating the molds from each other in a state that the molded molding is supported on the first mold and to output to the coating device: a moving instruction to move the coating device so as to butt it against the molding supported on the first mold in a state that the molds are separated from each other, a coating instruction to instruct the butted coating device to perform coating, and a separating instruction to separate the coating device from the coated molding.

An exemplary aspect of the invention includes an apparatus for producing a coated molded product comprising: an injection-molding device including first and second molds that are constructed to move relative to each other so as to separate from and come into contact with each other in opposite directions of mold surfaces, an injecting device that performs injection-molding, and a moving device that moves the molding; a coating device that coats a molding; and a controller that outputs operation control instructions to the injection-molding device and coating device, wherein the controller outputs, to the injection-molding device and the coating device: a butting instruction to butt mold surfaces for molding against each other; an injecting instruction to injection-mold a molding; a demolding instruction to separate the molds from each other in a state that the molded molding is supported on the first mold; a butting instruction to move and butt a molding supported on the first mold after being demolded from the molds to and against the coating device; a coating instruction to coat the butted molding; and a separating instruction to separate the coated molding from the coating device.

An exemplary aspect of the invention includes an apparatus for producing a coated molded product comprising: an injection-molding device including first and second molds that are constructed to move relative to each other so as to separate from and come into contact with each other in opposite directions of mold surfaces and move parallel to each other along the surface direction, and an injecting device that performs injection-molding; a coating device that coats at least one of the moldings, and a moving device that moves the coating device; and a controller that outputs operation control instructions to the injection-molding device and coating device, wherein the controller outputs, to the injection-molding device: a first injection control instruction composed of a first butting instruction to butt the mold surfaces to form first and second moldings formed on both molds against each other and a first injecting instruction to injection-mold the first and second moldings, and a demolding instruction to demold by separating the molds from each other in a state that the molded first and second moldings are supported on at least one of the molds; the controller outputs, to the coating device: a coating control instruction composed of a butting instruction to move the coating device so as to butt it against at least one of the demolded moldings, a coating instruction to coat the butted molding, and a separating instruction to separate the coating device from the coated molding and moving the coating device to the outside of the mold; and the controller outputs, to the injection-molding device: a second injecting control instruction composed of a second butting instruction to butt the first mold and the second mold against each other so that the coated molding and the other molding are butted against each other, a second injecting instruction to bond the first and second moldings together, and a demolding instruction to demold by separating the molds from each other.

An exemplary aspect of the invention includes an apparatus for producing a coated molded product comprising: an injection-molding device including first and second molds that are constructed to move relative to each other so as to separate from and come into contact with each other in opposite directions of mold surfaces and move parallel to each other along the surface direction, and an injecting device that performs injection-molding; a coating device that coats at least one of the moldings, and a moving device that moves the coating device; and a controller to output operation control instructions to these injection-molding device and coating device, wherein the controller outputs, to the injection-molding device and the coating device: a first injecting instruction to injection-molding first and second moldings by butting mold surfaces for forming the first and second moldings formed on both molds, against each other; a first demolding instruction to demold by separating the molds from each other in a state that the molded first and second moldings are supported on at least one of the molds; a moving instruction to demold at least one of the supported moldings from the mold and moving the molding so as to be butted against the coating device; a coating instruction to form coating on the butted molding to form a coated molding; and a second injecting instruction to move the coated molding so as to be placed into the mold on the side facing the other molding, butting the first and second molds against each other so that the coated molding and the other molding butt against each other, and injection-molding for boding the first and second moldings together.

According to exemplary aspects of the invention, a coated molded product can be easily produced by using an existing injection-molding device.

According to exemplary aspects of the invention, coating is easily performed.

According to exemplary aspects of the invention, a portion that should not be coated can be covered by a masking provided in the coating device and the workability is improved.

According to exemplary aspects of the invention, free coating is possible.

According to exemplary aspects of the invention, a surface different from a surface that is exposed when molds are separated from each other can be coated.

According to exemplary aspects of the invention, a portion that should not be coated can be covered by a masking provided in the coating device, and the workability is improved.

According to exemplary aspects of the invention, the coating work can be improved in efficiency.

According to exemplary aspects of the invention, complicated coating can be easily performed.

According to exemplary aspects of the invention, a selected molded product can be easily coated.

According to exemplary aspects of the invention, the coating work can be improved in efficiency.

According to exemplary aspects of the invention, various coatings can be made.

According to exemplary aspects of the invention, the coating work can be improved in efficiency.

According to exemplary aspects of the invention, the moving means can be easily constructed.

### BRIEF DESCRIPTION OF THE DRAWINGS

The description of the exemplary embodiments will be made with reference to the drawings, in which:

FIG. 1A is a schematic view of coating and molding devices and FIG. 1B is a longitudinal sectional view of a coated molded product;

FIG. 2A, FIG. 2B and FIG. 2C are schematic views showing the steps until first injection;

FIG. 3A is a schematic view showing the step of separating step a movable mold and FIG. 3B is a schematic view showing the step of moving the mold in a parallel manner;

FIG. 4A is step schematic views of a butting step of the coating device against a first molding and FIG. 4B is a step schematic view of a coating step on the first molding;

FIG. 5A is a step schematic view showing the step of butting the coating device against a second molding and FIG. 5B is a schematic view showing the step of a coating the second molding;

FIG. 6A is a schematic view sowing the step of moving the coating device outside of the injection-molding device, FIG. 6B is a schematic view showing a second butting step, and FIG. 6C is a schematic view showing a second injecting step;

FIG. 7A is a schematic view showing a second demolding step and FIG. 7B is a schematic view showing a product taking-out step;

FIG. 8A is a schematic view of a coating step for a second embodiment,

FIG. 8B is a schematic view of a coating step showing a variation of the second embodiment, and FIG. 8C is a schematic view of a coating step showing another variation;

FIG. 9A is a schematic view of a demolding step, FIG. 9B is a schematic view of a fitting member fitting step, and FIG. 9C is a schematic view of a coating step in a third embodiment;

FIG. 10A is a schematic view showing a moving step, FIG. 10B is a schematic view showing a masking setting step, FIG. 10C is a schematic view showing a coating step, and FIG. 10D is a schematic view showing a fitting member setting step of a coating device of a fourth embodiment;

FIGS. 11A and 11B are schematic views showing a coating and molding devices of a fifth embodiment and a longitudinal sectional view of a coated molded product, respectively;

FIG. 12A is a schematic view of a mold separating step, FIG. 12B is a schematic view of a first mold butting step, FIG. 12C is a schematic view of a first injecting step, and FIG. 12D is a schematic view of a first demolding step of a fifth embodiment, respectively;

FIG. 13A is a schematic view showing a moving device setting step, FIG. 13B is a schematic view showing a step of setting into a coating device, and FIG. 13C is a schematic view showing a coating step of a fifth embodiment, respectively;

FIG. 14A is a schematic view showing the process of setting a first molding on a second molding, FIG. 14B is a schematic view showing the process of an out-of-device moving step of the moving device, and FIG. 14C is a schematic view showing the process of a second mold butting step of a fifth embodiment, respectively;

FIG. 15 is a schematic view showing a coating step of a sixth embodiment;

FIG. 16A is a schematic view showing the step of demolding a molding from a mold, FIG. 166B is a schematic view of showing the step of setting a molding into a coating mold material, and FIG. 16C is a schematic view of showing the step of coating in a seventh embodiment; and

FIG. 17A is a schematic view showing the step of demolding a molding, FIG. 17B is a schematic view of a first coating step, FIG. 17C is a schematic view showing the step of setting a molding into a coating mold material, and FIG. 17D is a schematic view of a second coating step showing of an eighth embodiment.

### DETAILED DESCRIPTION OF EMBODIMENTS

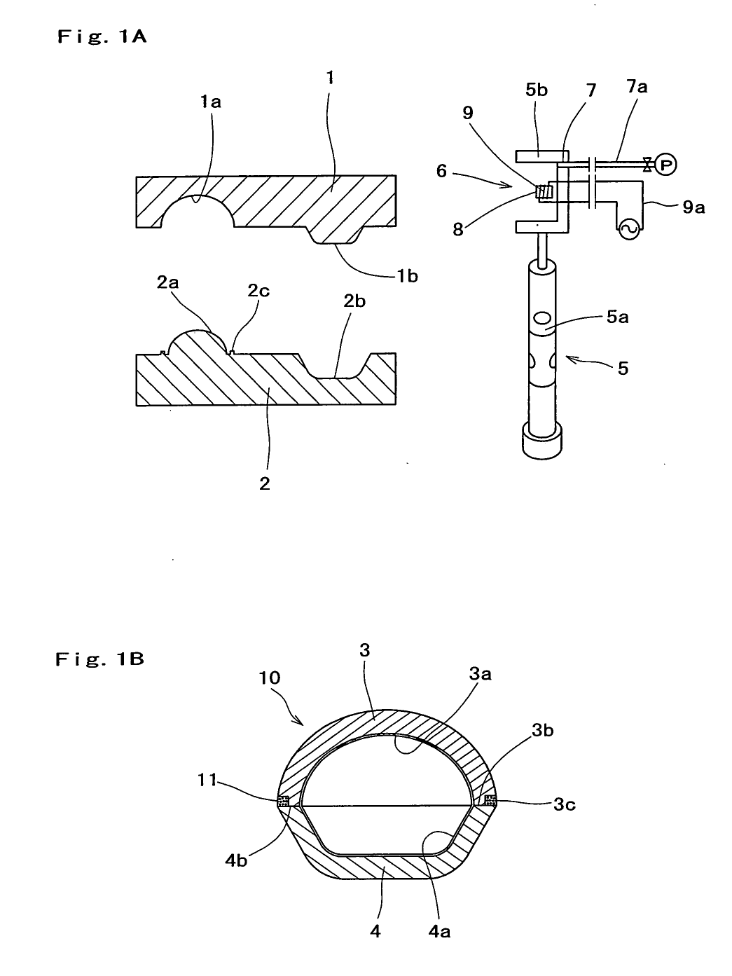

Next, a first embodiment of the present invention will be described with reference to FIGS. 1 through 7. In the drawings, the reference numeral 1 denotes a movable mold (first mold) and 2 denotes a fixed mold (second mold). The movable mold 1 is movable so as to come into contact with and separate from the fixed mold 2 in opposite directions. The movable mold 1 is movable in a direction along the mold surface (parallel to the mold surface) of the fixed mold in a state that it is separated from the fixed mold 2. The moving mechanism by which the movable mold 1 can be moved may be realized by using any technique conventionally known in the art, and thus the details thereof are omitted. The movement of the mold is only relative. Therefore it can also be accomplished by having the first mold fixed while the second mold is movable. Alternatively, both can be made movable. The movement is not limited to the parallel linear movement as long as the movement is along the mold surface. As such, it may be even rotative movement around an axis.

On the movable mold 1, an injection-mold surface 1a is formed into a concave shape for injection-molding a first molding 3 and an injection-mold surface 1b is formed into a convex shape for forming a second molding 4. Complimentary surfaces are formed on the fixed mold 2, such that an injection-mold surface 2a is formed in a convex shape for injection-molding the first molding 3, an injection-mold surface 2b is formed in a concave shape for forming the second molding 4, and a mold surface 2c is formed to create an injection margin 3c for bonding the first and second moldings 3 and 4 together.

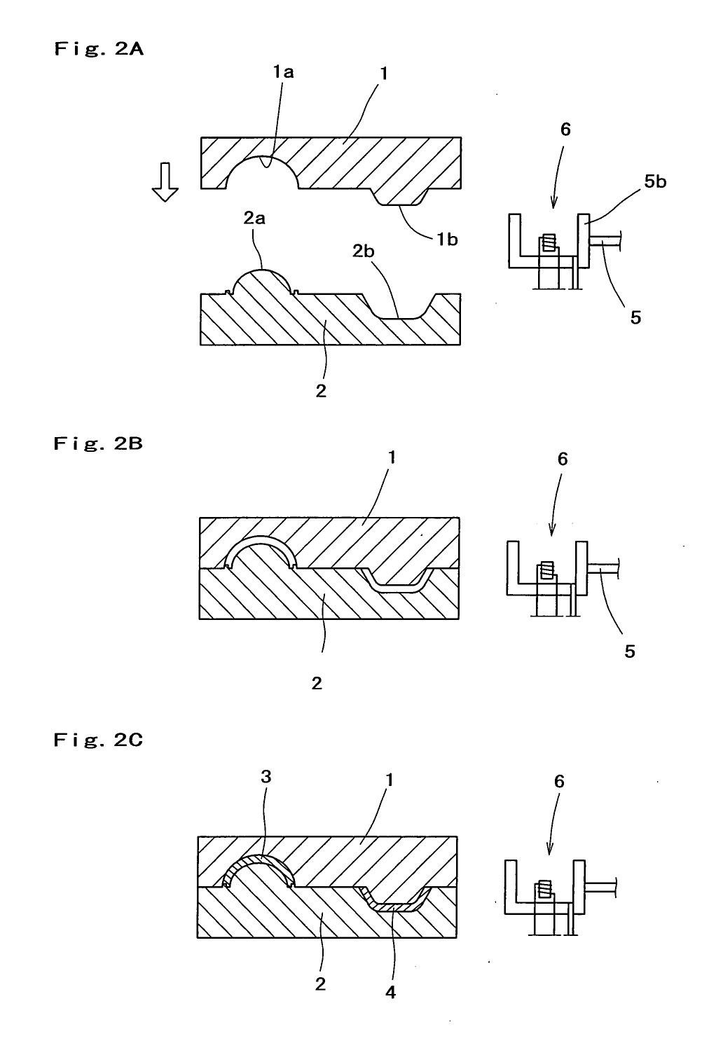

Reference numeral 5 denotes a robotic hand (manipulator, magic hand) arranged near an injection-molding device constructed by using various members including the molds 1, 2, an injection-molder that is not shown, and a mold moving means. The robot hand 5 has a joint arm 5a is designed to freely swing and rotate with a casing 5b at the tip end of the joint arm 5a. The casing 5b has a rectangular shape so as to accommodate a vacuum evaporation system 6 (coating forming means, coating device) that is provided rotatably around the axis. The robot hand 5 can displace the vacuum evaporation system 6 within a three-dimensional area aided by the swing and rotation qualities of the joint arm 5a and the rotation of the casing 5b. However, these also use a technique generally known so that details thereof are omitted. Thus, in FIGS. 2A-2B and subsequent drawings, only the casing 5b and the vacuum evaporation system 6 are shown.

The generally known vacuum evaporation system 6 is provided. In summary, it comprises an intake channel 7 to be connected to a vacuum pump P via a hose 7a drawn out of the casing 5b, a boat 8 in which a metal (for example, aluminum or chrome) to be deposited is placed, and a heater 9 to be connected to a power source via an electric wire 9a drawn out of the casing 5b for heating the boat 8. Hose 7a and electric wire 9a can also be directly provided on the robot hand, such as on the casing 5a. The present invention is not limited to the above-described embodiment, and the coating means is not limited to the vacuum evaporation system 6. For example, other conventionally known coating techniques, such as coating by means of cathode sputtering, can be employed where appropriate.

The process for producing a coated molded product 10 by using the first and second moldings 3, 4 will be described. In this embodiment, the description is given with respect to producing a hollow emblem with inner surfaces of the first and second moldings 3, 4 to be coated. First, in FIGS. 2A-2C, the process for producing first and second moldings 3, 4 in the first injecting step is schematically shown. FIG. 2A shows a state in which the corresponding surfaces of the movable mold 1 and the fixed mold 2 face each other, such that the mold surfaces 1a and 2a face each other, and the mold surfaces 1b and 2b face each other in a manner that corresponds to the first and second moldings 3, 4. From this state, the movable mold 1 moves so as to butt against the movable mold 2 in a butted state (see FIG. 2B). In this butted state, the first injecting step is executed and the first and second moldings 3, 4 are molded without a coating.

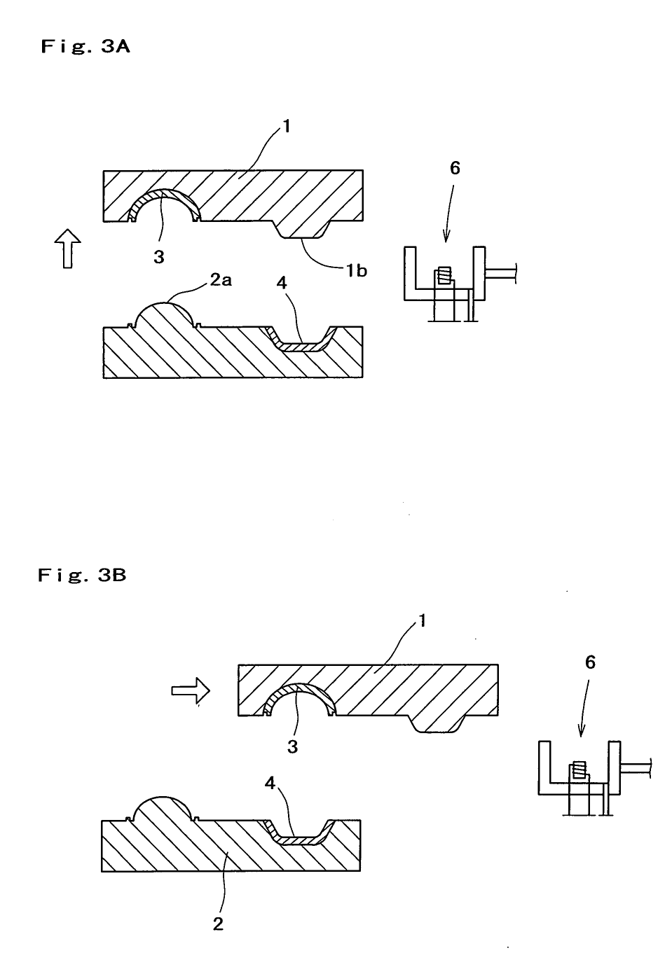

Then, the movable mold 1 is separated from the fixed mold 2. At this time, the mold surface is such that the first molding 3 remains on the movable mold 1 side and the second molding 4 remains on the fixed mold 2 side (see FIG. 3A). The movable mold 1 moves parallel to the mold surface such that the facing distance between these molds is maintained in a position at which the first and second moldings 3, 4 face each other (see FIG. 3B).

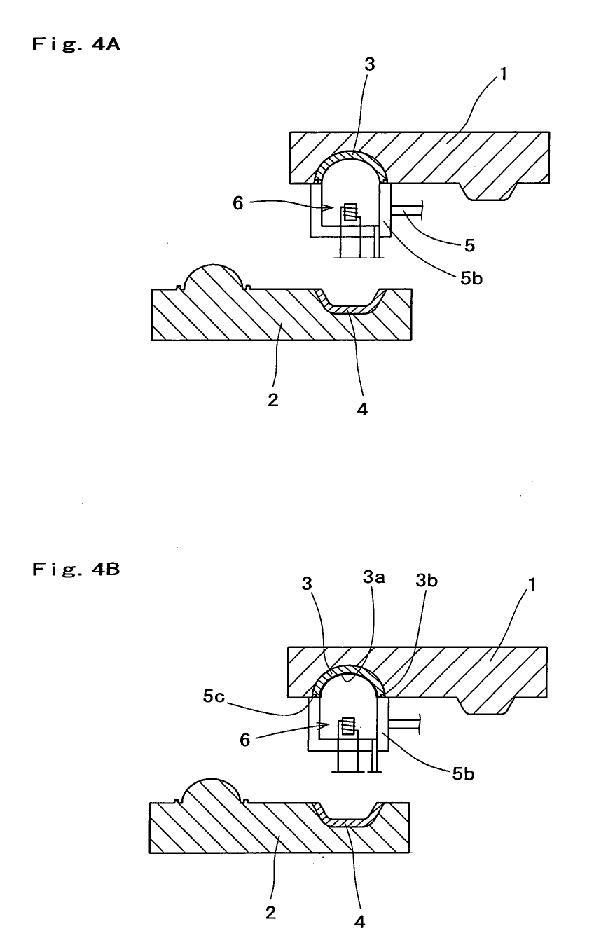

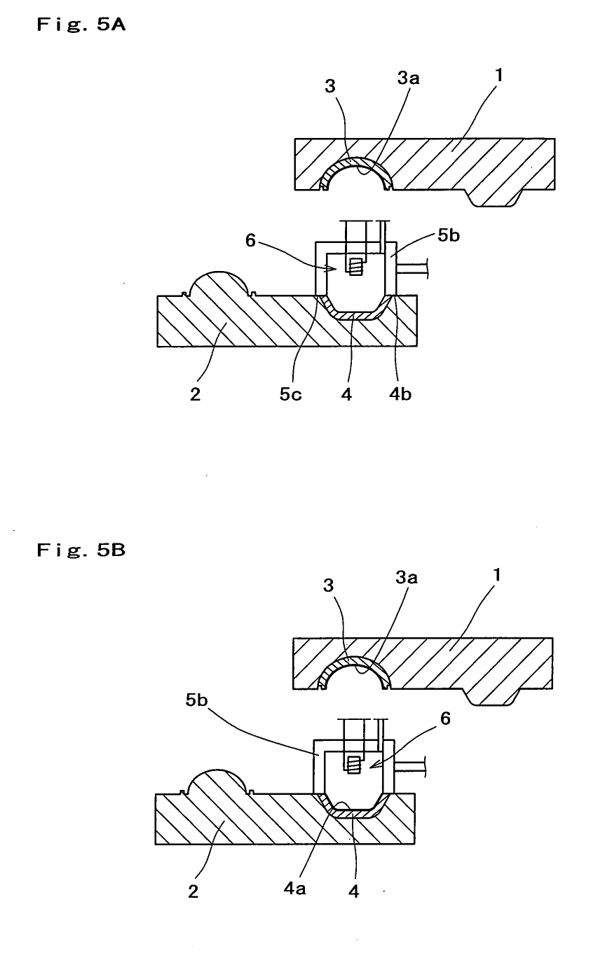

As can be seen in FIG. 4A, such a separated state, the casing 5b is butted against the mold surface 1a of the movable mold 1 by operation of the robot hand 5 (see FIG. 4A). As shown in FIG. 4B, coating 3a is applied on the inner surface of the first molding 3 by the vacuum evaporation system 6. In this case, by butting the end face 5c of the casing 5b, the end face 3b of the first molding 3 is masked. As shown in FIG. 5A, when coating on the first molding 3 is finished, the robot hand 5 moves the casing 5b to the second molding 4 side and turns over to butt the casing 5b against the mold surface 2b of the fixed mold. As shown in FIG. 5B, coating 4a is applied on the inner surface of the second molding 4. Also described above, the end face 4b of the second molding 4 is masked by the casing end face 5c. It is obvious that, the coating step can be performed even when the molds are moved with respect to each other as shown in FIG. 3A.

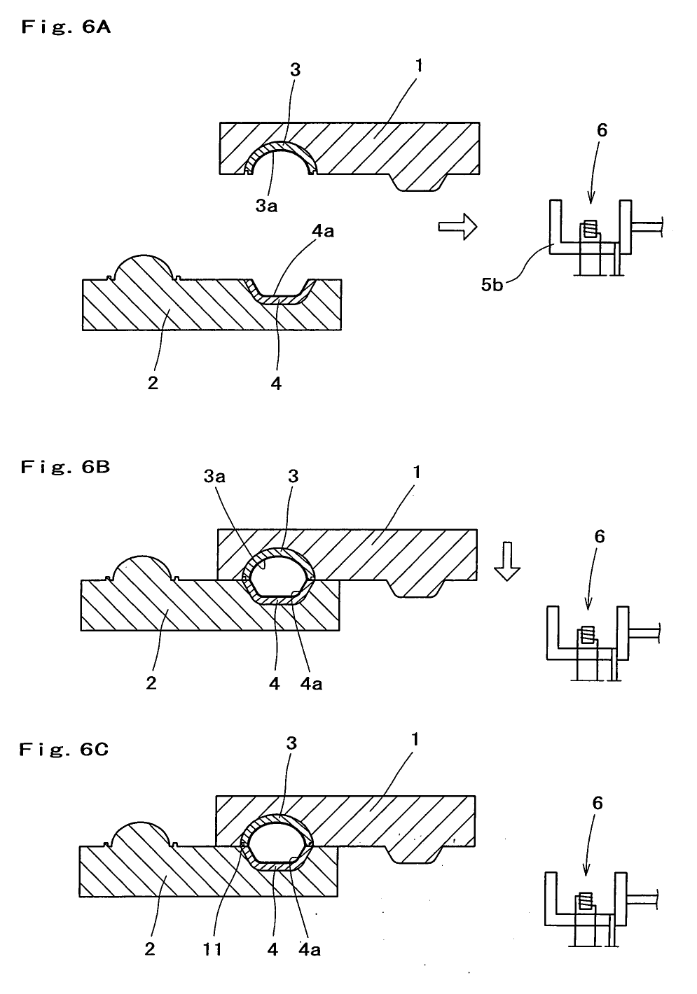

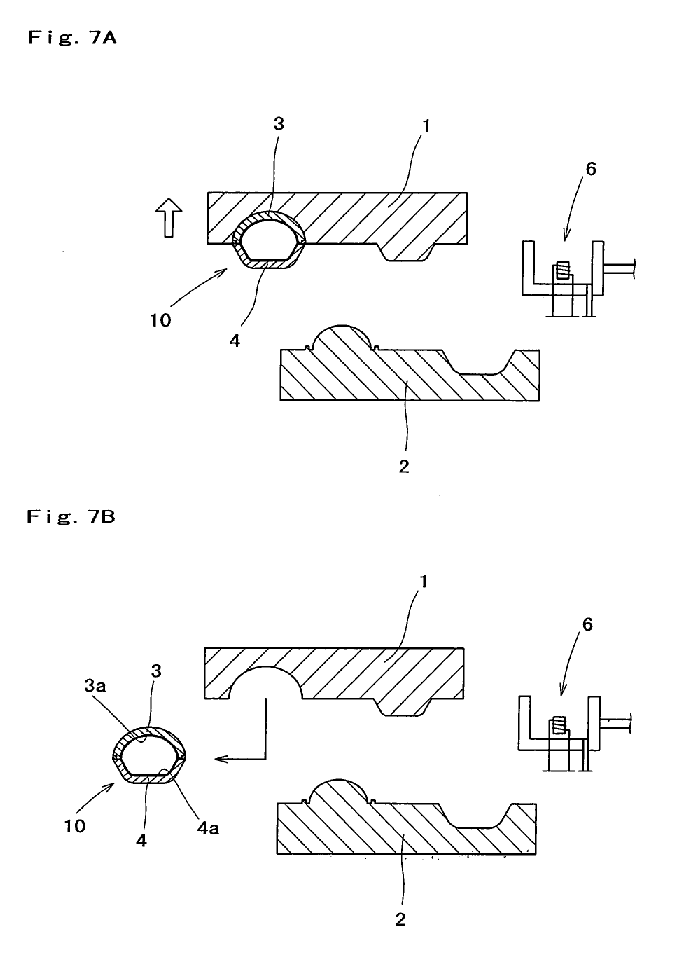

As shown in FIG. 6A, when the inner surfaces of the first and second moldings 3, 4 are coated with the coatings 3a, 4a, the casing 5b moves to the outside of the injection-molding device through operation of the robot hand 5. As shown in FIG. 6B, the movable mold 1 then moves so as to butt against the fixed mold 2. Thereby, the end faces of the first and second moldings 3, 4 are butted against each other such that the injection margin 3c becomes a void space. As shown in FIG. 6C, the injection margin 3c is subjected to the second injecting step, and the first and second moldings 3, 4 are thus integrally bonded together by the injection of a resin material 11. Thus, the first and second moldings 3, 4 are demolded due to separation of the movable mold 1 from the fixed mold 2. The completed coated molded product 10 is taken out from the fixed mold 2, whereby the series of steps for producing the coated molded product 10 is completed (see FIGS. 7A and 7B). Thereafter, the movable mold 1 moves to the position of FIG. 2A to enable repeated production of the coated molded product 10.

In an embodiment constructed as described above, the first and second moldings 3, 4 are injection-molded in the first injecting step, and then coated with coatings 3a, 4a by the vacuum evaporation system 6. The vacuum evaporation system 6 moves outside the injection-molding device after coating, and as a result, the injection-molding and coating can be successively performed in a series of operations. In addition, because the vacuum evaporation system 6 is not provided in the mold 1 or 2 an existing injection-molding device can be used as post-attached equipment so that equipment investment can be reduced.

In addition, in the above-described embodiment, the first and second moldings 3, 4 are coated when they are still warm and immediately after being injected. Thus, the bonding performance of the coating materials to the resin material is superior and results in an excellent appearance. In addition, by making the plurality of moldings 3 and 4 equal in shape the plurality of first and second moldings 3, 4 can be successively coated by using one vacuum evaporation system in an efficient production of coated moldings.

In addition, the first and second moldings 3, 4 coated with the coatings 3a, 4a can be butted against each other due to mold movements and integrally bonded by the second injecting step in a serial flow of steps, so that the workability is improved.

It is as a matter of course that the present invention is not limited to the above-described embodiment. For example, both moldings are coated with coatings, however, it is also possible that the only one mold is coated, or coating is applied to a plurality of moldings in an alternating order (i.e., the molding to be coated is changed, for example, such that the first molding, the second molding, and then the first molding is coated again.

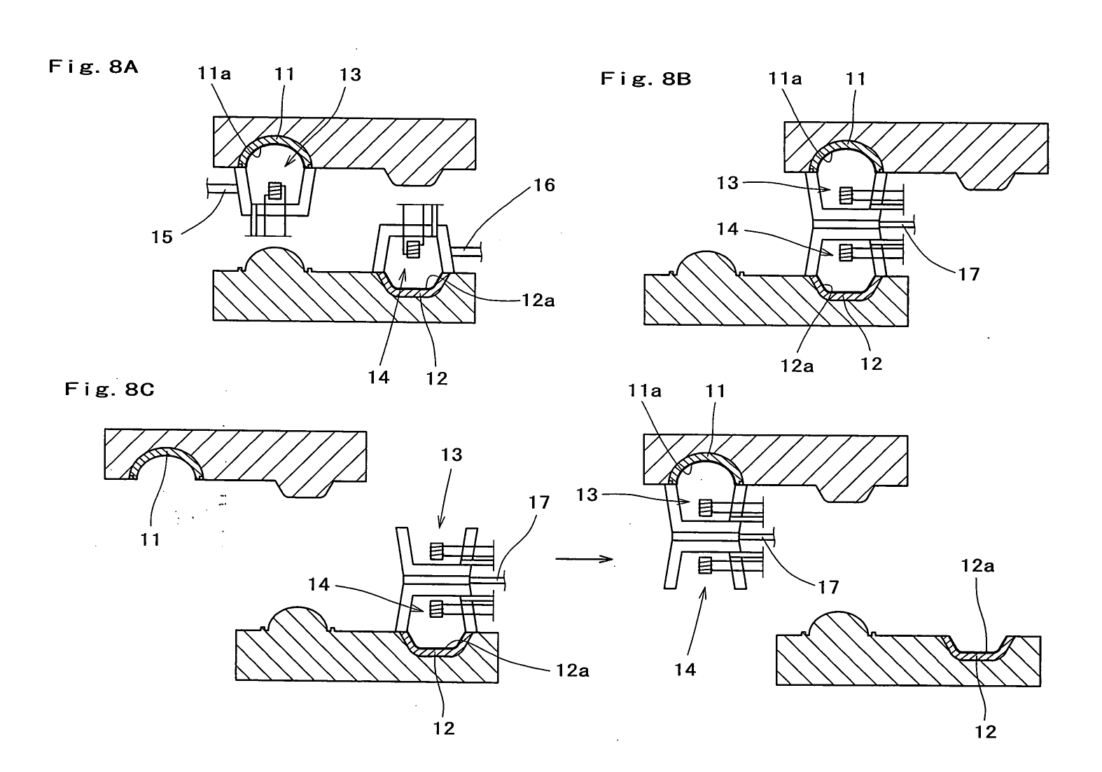

As in the second embodiment, shown in FIGS. 8A-8C, when a plurality of moldings 11, 12 are molded, it is also possible that they are simultaneously coated with coatings 11a, 12a by using a plurality of coating means 13, 14. Then, in the case at hand, the coating materials of the coating means 13, 14 may be the same or different. As shown in FIG. 8A, the coating can be performed by providing the coating bodies 13, 14 on the respective robot hands 15, 16. As shown in FIG. 8B, it is also possible that one robot hand 17 is provided with a plurality of opposing coating means 13, 14 such that the coatings 11a, 12a are simultaneously formed. The coatings 11a, 12a can also be performed sequentially as shown in FIG. 8C. In this case, the coatings of the coating means 13, 14 may be the same or different. In order to make coatings different, the coating materials can be different, the coating times can be different, or the like.

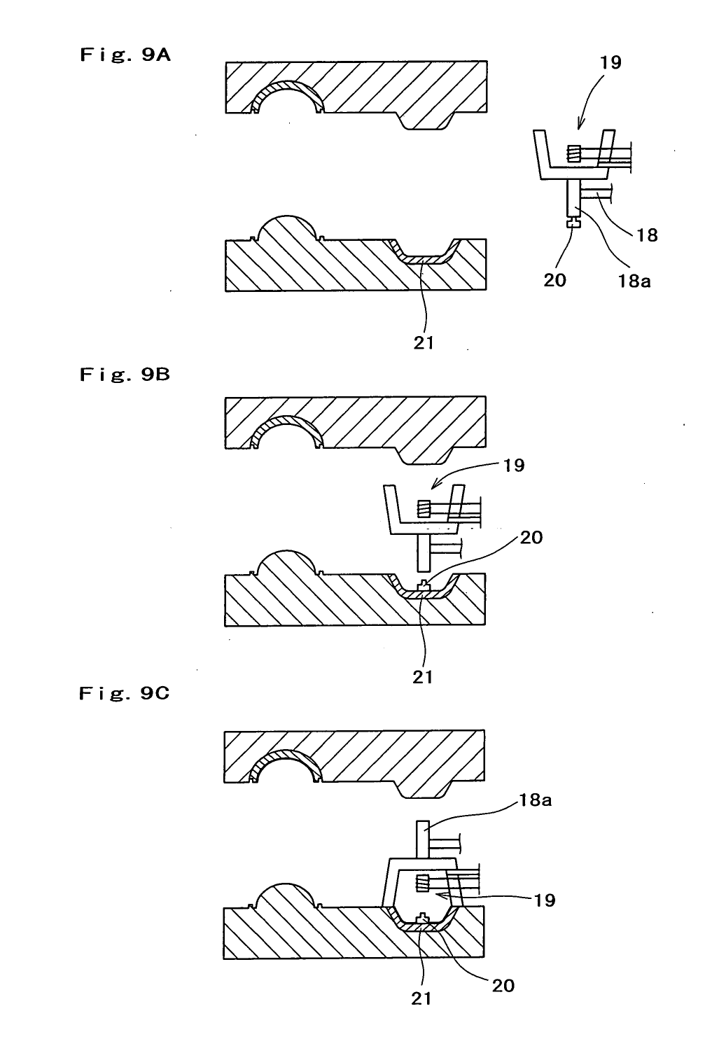

Furthermore, in the third embodiment shown in FIGS. 9A-9C, a coating means 19 is provided at the tip end 18a of the robot hand 18. A fitting member (installed item) 20 (or masking material) is detachably supported, the fitting member 20 being fitted to the molding 21 before coating (in the case of the masking material, it is removed after coating). Thereby, it becomes possible to produce a greater variety of molded products.

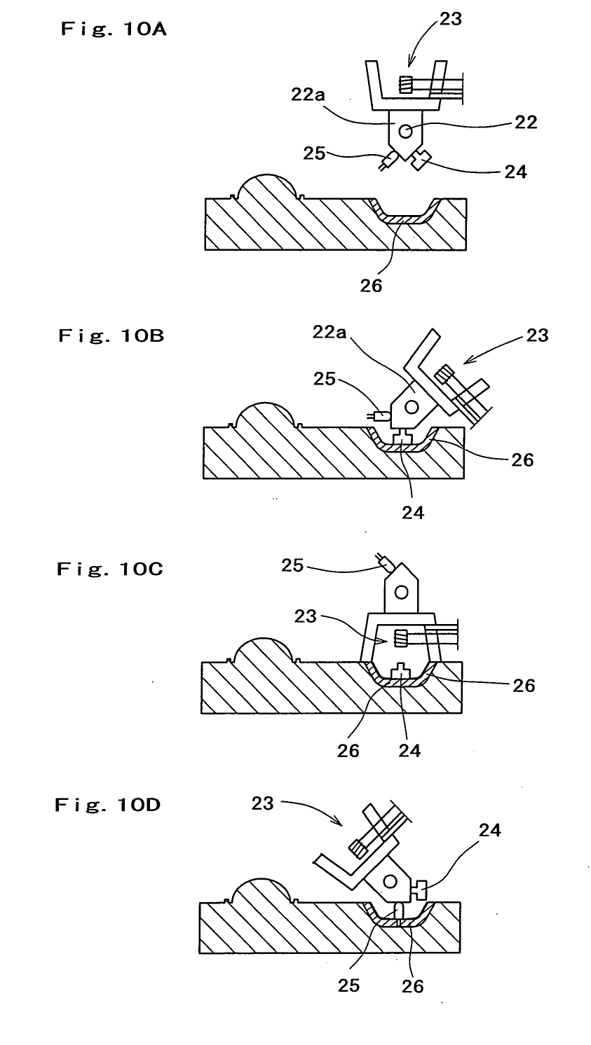

Furthermore, in the fourth embodiment shown in FIGS. 10A-10D, it is also possible that in addition to attaching the coating device 23 to the tip end 22a of the robot hand 22, a masking material 24 and a fitting member 25 are detachably supported. Molding 26 is masked by masking material 24 and then coated by a coating device 23. Thereafter, the masking material 24 is removed, and the fitting member 25 is fitted. In FIGS. 10A-10D, the complimentary mold is omitted.

In each embodiment described above, the coating device is moved by a robot hand with a moving means to the inside and outside of the injection-molding device. However, it is also possible that the molding is moved to the outside of the injection-molding device by a moving means and set and coated in a coating device provided outside the injection-molding device. This embodiment will be described with respect to a fifth embodiment.

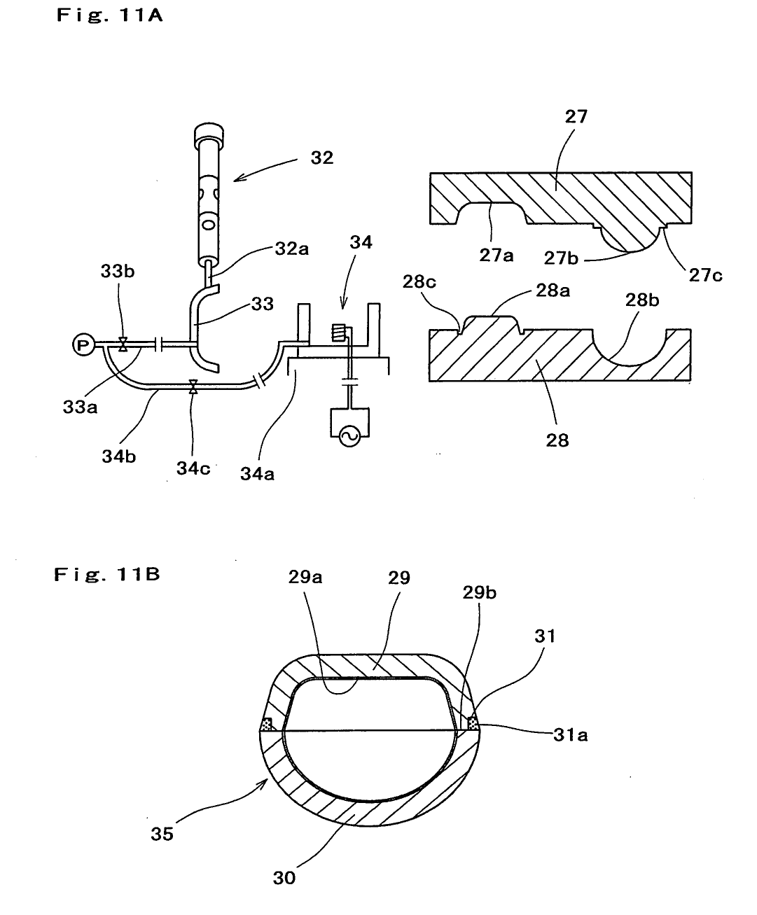

FIGS. 11 through 14 describe a fifth embodiment which comprises a movable mold 27 and a fixed mold 28. On the movable mold 27 is such that a concave mold surface 27a for forming a first molding 29 is formed, a convex mold surface 27b for forming a second molding 30 is formed, and a convex mold surface 27c for forming a connection margin 31 in a second injecting step is further formed on the convex mold surface 27b side. On the fixed mold 28, a convex mold surface 28a for forming the first molding 29 and a concave mold surface 28b for forming the second molding 30 are formed, and a concave mold surface 28c for forming the connection margin 31 in the second injecting step is further formed.

Furthermore, the robot hand 32 is constructed so that its tip end 32a is three-dimensionally freely movable similar to that in the first embodiment. On the tip end 32a, a moving member 33 for supporting, taking-out (demolding), and moving the first molding 29 from the fixed mold 28 is provided.

Various tools such as a holder or an engagement tool, may be used as the moving member 33. In this embodiment, a vacuum method is used in which a fitting member 32b is fitted on the first molding 29 on the demolding exposed side. A vacuum and close-contact state is made between the member and the first molding 29 by a connected vacuum pump P and the first molding is demolded. As the coating device 34, a vacuum evaporation system similar to that used in the first embodiment is arranged on a base 34a. In this embodiment, the moving member 33 and the coating device 34 are connected to the vacuum pump P via exclusive flow channels 33a, 34b, respectively. The flow channels 33a, 34b are opened and closed independently by opening and closing valves 33b, 34c provided in the respective flow channels 33a, 34b to make the moving member 33 and the coating device 34 vacuum.

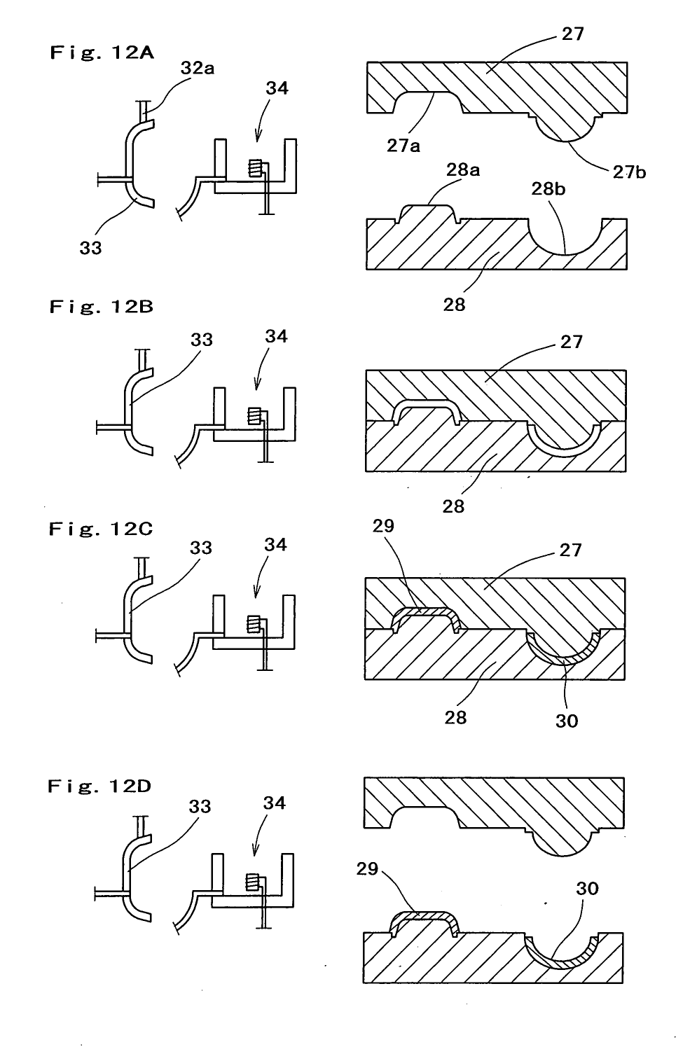

Next, a process for producing a coated molded product 35 molded by integrally bonding the first and second moldings 29, 30 will be described. The steps up to the first injecting step of FIGS. 12A through 12C are the same as in the first embodiment, so that description thereof is omitted herein. The mold design is such that the first molding 29 remains on the fixed mold 28 side in a demolding step after finishing the first injecting step (see FIG. 12D).

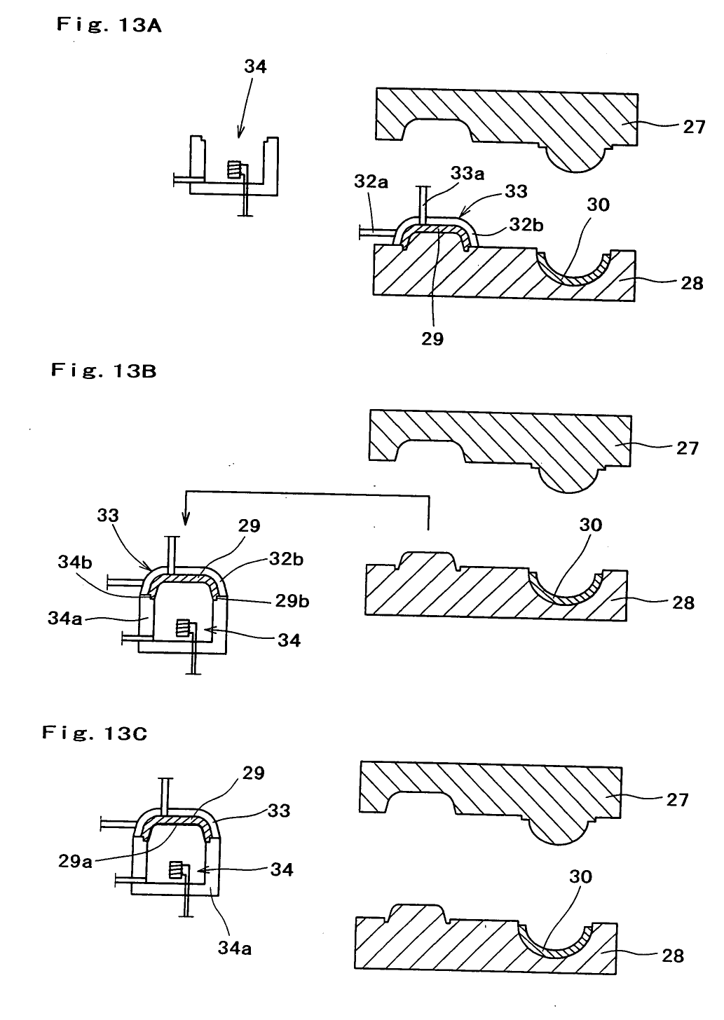

As shown in FIG. 13A, the process enters the coating step. In this embodiment, a fitting member 32a is fitted on the first molding 29 and the vacuum pump P is actuated to make a vacuum state and bring the first molding 29 into close contact with the fitting member 32a. In this state, the fitting member 32a is moved and the molding is demolded from the fixed mold 28 and set into the coating device 34. The tip end 34b of the casing 34a in the coating device 34 is masked by contact with the tip end 29b of the first molding 29 (see FIG. 13B). As shown in FIG. 13C, the coating device 34 is operated and can form coating 29a on a surface on the side that is exposed when being demolded from the fixed mold 28 to take-out the first molding 29 and not on the surface of the first molding 29 which is demolded from the movable mold 27 and exposed when the molds 27 and 28 are separated from each other.

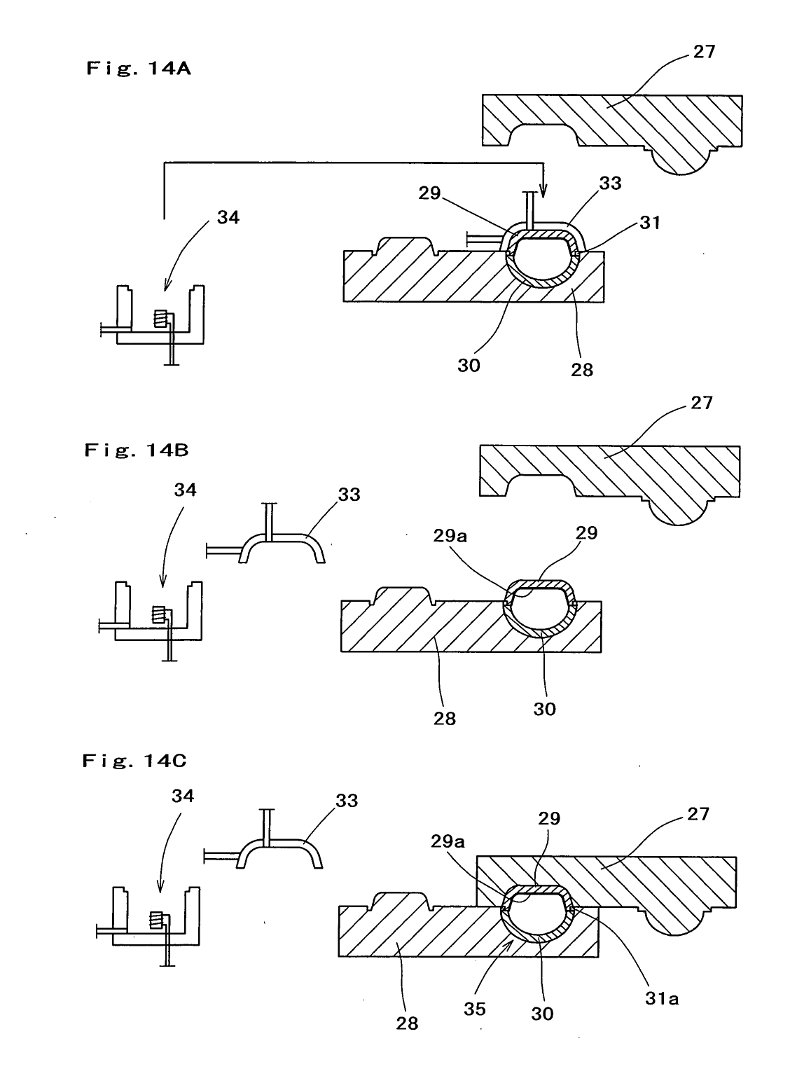

The first molding 29, thus coated with the coating 29a, is butted against the second molding 30 held in the fixed mold 27 by moving the robot hand 32 (see FIG. 14A). Thereafter, air is supplied into the fitting member 32a to remove the first molding 29 from the fitting member 32a (see FIG. 14B). The movable mold 27 is moved and the removed first molding 29 is fitted and set in the concave mold surface 27a. In this state, the second injecting step is performed to inject the resin material 31a to the connection margin 31 (see FIG. 14C), whereby a coated molded product 35 including the coating 29a coated on the first molding 29 is formed. Thereafter, demolding and the taking-out of the coated molded product 35 are performed by means of a separating movement of the movable mold 27. The series of producing steps for the coated molded product 35 are executed, and by repeating these steps, coated molded products 35 are successively produced.

In the embodiment of the present invention described above, the first molding 29 is one of the first and second moldings 29, 30 constituting the produced coated molded product 35. The first molding 29 is injection-molded through the first injecting step and then moved from the inside to the outside of the injection molding device. The first molding 29 is then set in the coating device 34 and coated with coating 29a. And as a result, injection-molding and coating can be successively performed by the series of operations. In addition, because the coating device 34 is not provided in the mold 1 or 2, an existing injection-molding device can be used as it is, and the coating device can be used as post-attached equipment to reduce the overall equipment investment.

Furthermore, because the injected molding is moved outside the injection-molding device and then coated, a surface hidden in the mold can be coated, and not the surface that is exposed when demolded by separating the movable mold 27 from the fixed mold 28. Thus diversification of the coating formation can be obtained.

In addition, in the above-described embodiment, because coating is performed immediately after the first and second moldings 3, 4 are injected, they are still warm. Thus, the bonding performance of the coating material to the resin material and appearance are enhanced. Furthermore, by making all the moldings 3 and 4 equal in shape, the plurality of first and second moldings 3 and 4 can be successively coated with one vacuum evaporation system resulting in an efficient production of coated moldings.

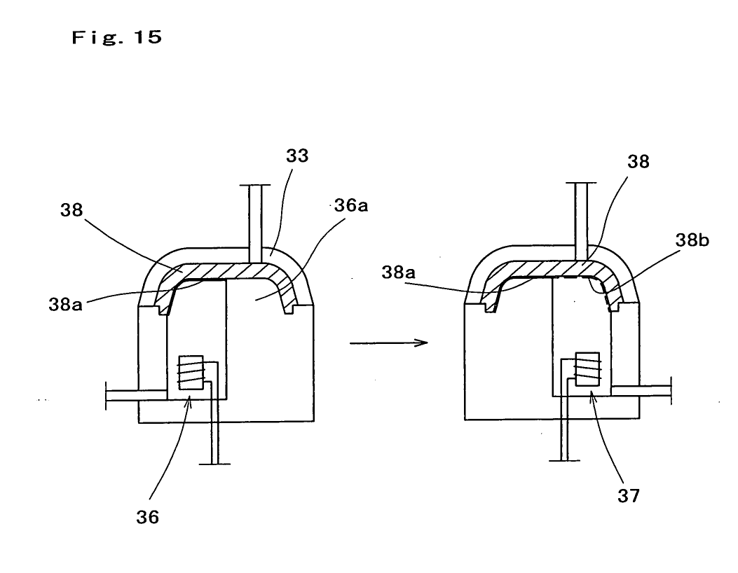

Instead of coating upon moving the molding to the outside of the injection-molding device, it is also possible that the moldings 29, 30 are taken out and moved and then coated. In this case, it is needless to say that coating can be performed by providing a separate masking material or a fitting member. As coating a plurality of coating devices are provided and perform coating or a plurality of coatings can be formed on one molding. As in the case of the sixth embodiment of FIG. 15, a plurality of coating devices 36, 37 are provided and masking is applied by using the masking portions 36a, 37a provided in these devices or separately prepared masking materials. Thus, a plurality of different coatings 38a, 38b can be formed on the molding 38.

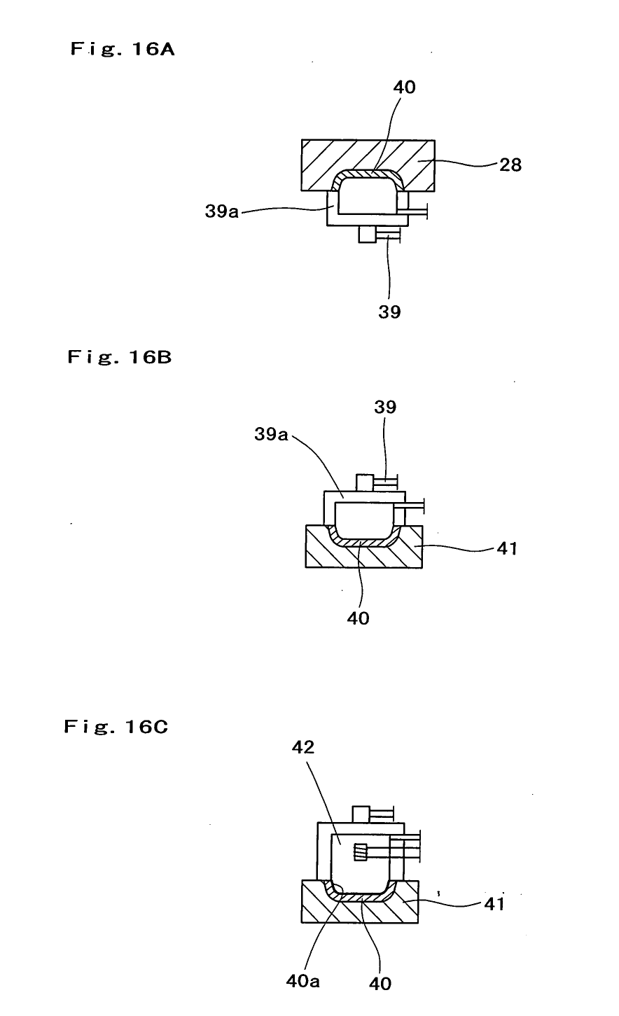

To this construction the seventh embodiment, shown in FIGS. 16A-16C, can also be applied. When taking-out the molding 40 from the injection-mold 28 and moving it outside the injection-molding device, the molding 40 can be taken out and moved by a movable body 39a provided on the tip end of the robot hand 39 and set in a separately provided mold material 41 (see FIG. 16B). As such, the molding 42 is set and coating is performed, and thereby, a surface is exposed when the movable mold is separated from the fixed mold can be coated with coating 40a.

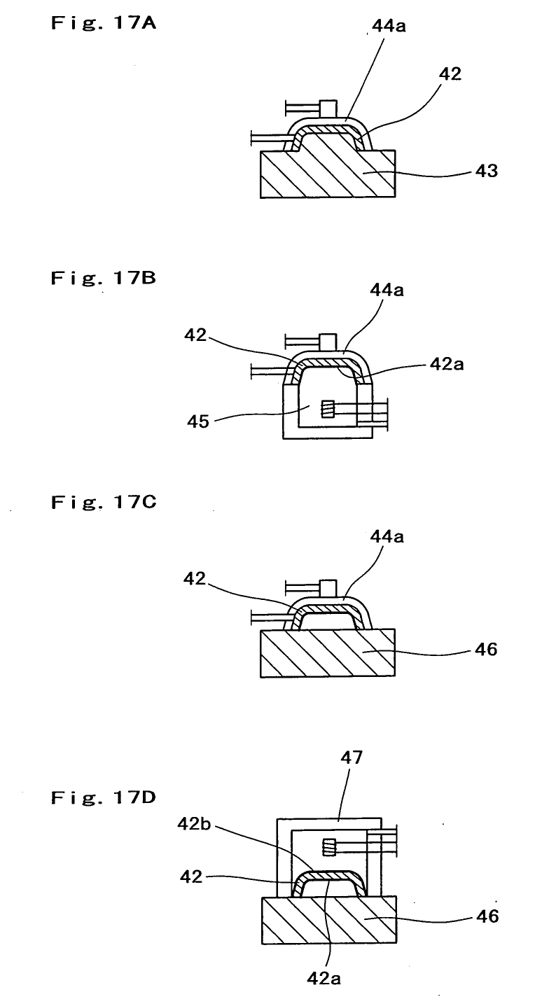

Furthermore, as in the case of the eighth embodiment, shown in FIGS. 17A-17D, it is also possible that coatings 42a, 42b are formed on both a surface that is exposed by separation from the mold 43 and a surface exposed by being separated from the mold 43 due to the movement of the molding 42. In this embodiment, the steps of the fifth embodiment can be used as the step for forming the coating 42a by the first coating device 45 on a surface that is exposed by separation from the mold 43 due to the movement of the molding 42 by the movable body 44a. The molding 42, coated with the coating 42a, is set in the mold material 46 so that the coating 42a comes to the inner side, the moving member 45a is separated from the molding 42, and whereby, demolding is performed by separating the fixed mold from the movable mold. In doing so, a surface is exposed, and is coated with the coating 42b by setting a second coating device 47 (may be the same as or different from the first coating device) on the mold material 46. Thereby, both surfaces can be coated, so that one aspect of the present invention can be carried out.

### INDUSTRIAL APPLICABILITY

The present invention is useful as a method for producing a coated molded product as a coated molding such as a front lamp, a tail lamp, or an emblem, etc., to be installed in a vehicle, and a production apparatus for molding and coating, and in particular, suitable for easily producing a coated molded product by using an existing injection-molding device.

While the invention has been described in the specification and illustrated in the drawings with reference to various embodiments, it will be understood by those skill in the art that various changes may be made and equivalents may be substituted for elements thereof without departure from the scope of the invention as defined in the claims. Furthermore, the mixing and matching of features, elements and/or functions between various embodiments is expressly contemplated herein so that one of ordinary skill in the art would appreciate from this disclosure that features, elements and/or functions of one embodiment may be incorporated into another embodiment as skill in the art would appreciate from this disclosure that features, elements and/or functions of one embodiment may be incorporated into another embodiment as appropriate, unless described otherwise, above. Moreover, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out the invention, but that the invention will include any embodiments falling within the foregoing description and the appended claims.

1. A method for producing a coated molded product including:
an injection-molding device including first and second molds that are constructed to move relative to each other so as to separate from and come into contact with each other in opposite directions of mold surfaces and have the mold that form a molding, and an injecting device that performs injection-molding; and
a coating device that coats the molding and a moving device that moves the coating device,
the method comprising:
injection-molding the molding by the injecting device after butting the mold surfaces against each other,
demolding the molded molding after separating the molds from each other in a state that the molding is supported on the first mold;
forming a coating on the molding by the coating device after moving the coating device so as to butt against the molding supported on the first mold in the state that the molds are separated from each other; and
separating the coating device from the coated molding.

2. A method for producing a coated molded product including:
an injection-molding device including first and second molds that are constructed to move relative to each other so as to separate from and come into contact with each other in opposite directions of mold surfaces and have the mold surfaces that form a molding, an injecting device that performs injection-molding, and a moving device that moves the molding;
a coating device that coats the molding,
the method comprising:
injection-molding a molding by the injecting device after butting the mold surfaces against each other;
demolding the molded molding after separating the molds from each other in a state that the molding is supported on the first mold;
butting the molding supported on the first mold against the coating device after being demolded from the molds;
forming a coating on the butted molding; and
separating the coated molding from the coating device.

3. A method for producing a coated molded product including:
an injection-molding device including first and second molds that are constructed to move relative to each other so as to separate from and come into contact with each other in opposite directions of mold surfaces and move parallel to each other along the surface direction and have mold surfaces that form first and second moldings, respectively, and an injecting device that performs injection-molding; and
a coating device that coats at least one of the moldings and a moving device that moves the coating device,
the method comprising:
injection-molding first and second moldings after butting the mold surfaces against each other;
demolding after separating the molds from each other in a state that the first molding is supported on the first mold and the second molding is supported on the second mold;
moving the coating device so as to butt against at least one of the demolded moldings and forming a coating on the butted molding to form a coated molding; and
injection-molding to bond the first and second moldings together after butting the first mold and second mold against each other so as to butt the coated molding and the other molding against each other.

4. A method for producing a coated molded product including:
an injection-molding device including first and second molds that are constructed to move relative to each other so as to separate from and come into contact with each other in opposite directions of mold surfaces and move parallel to each other, and have the mold surfaces that form first and second moldings, respectively, an injecting device that performs injection-molding, and a moving device that moves the moldings; and
a coating device that coats the moldings,
the method comprising:
injection-molding first and second moldings after butting the mold surfaces against each other, the mold surfaces for molding the first and second moldings formed on both molds;
demolding the molded first and second moldings after separating the molds from each other in a state that the molded first and second moldings are supported on at least one of the molds;
moving the coating device so as to butt against at least one of the demolded moldings;
forming a coated molding by forming a coating on the butted molding; and
injection-molding to bond the first and second moldings together after moving the coated molding so as to place it into a mold on the side facing the other molding, and butting the first mold and the second mold so that the coated molding and the other molding butt against each other.

5. The method for producing a coated molded product according to claim 1, wherein the coating device is a vacuum evaporation system.

6. The method for producing a coated molded product according to claim 1, wherein a coating is formed on a surface that is exposed due to separating molds from each other.

7. The method for producing a coated molded product according to claim 6, wherein the surface on which a coating is formed is a part of an exposed surface, and the coating on this part is performed by covering a portion that is not to be coated by a masking provided by the coating device.

8. The method for producing a coated molded product according to claim 1, wherein the surface on which the coating is formed is a part of an exposed surface exposed due to separating molds from each other, and coating on this part is performed by butting the coating device against it after covering a portion that is not to be coated by a masking detachably provided by the moving device.

9. The method for producing a coated molded product according to claim 2, wherein a surface on which the coating is formed is a surface exposed due to demolding from the molds by the moving device.

10. The method for producing a coated molded product according to claim 9, wherein a surface on which coating is formed is a part of an exposed surface, and coating on the part is performed by covering a portion that is not to be coated by a masking provided by the coating device.

11. The method for producing a coated molded product according to claim 1, wherein the coating step is performed a plurality of times by a plurality of coating devices provided movably in the moving device.

12. The method for producing a coated molded product according to claim 1, wherein the coating step is performed a plurality of times by the coating device provided, respectively, in a plurality of moving devices.

13. The method for producing a coated molded product according to claim 1, wherein on the first and second molds, mold surfaces for molding a plurality of moldings are formed respectively, and the coating step is for coating at least one of the plurality of moldings molded through the injecting step.

14. The method for producing a coated molded product according to claim 13, wherein when a plurality of moldings are coated, coatings on the plurality of moldings are the same.

15. The method for producing a coated molded product according to claim 13, wherein when a plurality of moldings are coated, coatings on the plurality of moldings are different from each other.

16. The method for producing a coated molded product according to claim 1, wherein the coating device comprises a plurality of coating devices provided movably in the moving device or a coating device provided in a plurality of moving devices respectively, the coating step is performed for the molding molded through the injecting step by at least one coating device selected among the plurality of coating devices.

17. The method for producing a coated molded product according to claim 11, wherein coatings to be formed on moldings by a plurality of coating devices are different between a previous molding and a current molding.

18. The method for producing a coated molded product according to claim 11, wherein a plurality of coatings are different in coating position from each other.

19. The method for producing a coated molded product according to claim 3, wherein a coating is formed on one of the first and second moldings.

20. The method for producing a coated molded product according to claim 3, wherein a coating is formed on both first and second moldings.

21. The method for producing a coated molded product according to claim 3, wherein a coating is formed on both first and second moldings, and coatings on the first and second moldings are formed by successively moving the coating device.

22. The method for producing a coated molded product according to claim 4, wherein the coating is formed on both first and second moldings, and coatings on the first and second moldings are formed by successively moving the moldings by the moving device.

23. The method for producing a coated molded product according to claim 21, wherein coatings on both moldings are formed by individual coating devices provided for the respective moldings.

24. The method for producing a coated molded product according to claim 1, wherein the moving device is a manipulator.

25. An apparatus for producing a coated molded product comprising:
an injection-molding device including first and second molds that are constructed to move relative to each other so as to separate from and come into contact with each other in opposite directions of mold surfaces that form a molding, and an injecting device that performes injection-molding;
a coating device that coats a molding and a moving device that moves the coating device; and
a controller that outputs operation control instructions to the injection-molding device and coating device, wherein the controller is constructed so as to output to the injection-molding device:
a butting instruction to butt mold surfaces against each other, the mold surfaces being formed on both molds, and an injecting instruction for injection-molding a molding to the injecting device in the butted state; and
a demolding instruction to demold by separating the molds from each other in a state that the molded molding is supported on the first mold and
to output to the coating device:
a moving instruction to move the coating device so as to butt it against the molding supported on the first mold in a state that the molds are separated from each other,
a coating instruction to instruct the butted coating device to perform coating, and
a separating instruction to separate the coating device from the coated molding.

26. An apparatus for producing a coated molded product comprising:
an injection-molding device including first and second molds that are constructed to move relative to each other so as to separate from and come into contact with each other in opposite directions of mold surfaces, an injecting device that performs injection-molding, and a moving device that moves the molding;
a coating device that coats a molding; and
a controller that outputs operation control instructions to the injection-molding device and coating device, wherein
the controller outputs, to the injection-molding device and the coating device:
a butting instruction to butt mold surfaces for molding against each other;
an injecting instruction to injection-mold a molding;
a demolding instruction to separate the molds from each other in a state that the molded molding is supported on the first mold;
a butting instruction to move and butt a molding supported on the first mold after being demolded from the molds to and against the coating device;
a coating instruction to coat the butted molding; and
a separating instruction to separate the coated molding from the coating device.

27. An apparatus for producing a coated molded product comprising:
an injection-molding device including first and second molds that are constructed to move relative to each other so as to separate from and come into contact with each other in opposite directions of mold surfaces and move parallel to each other along the surface direction, and an injecting device that performs injection-molding;
a coating device that coats at least one of the moldings, and a moving device that moves the coating device; and
a controller that outputs operation control instructions to the injection-molding device and coating device, wherein
the controller outputs, to the injection-molding device:
a first injection control instruction composed of a first butting instruction to butt the mold surfaces to form first and second moldings formed on both molds against each other and a first injecting instruction to injection-mold the first and second moldings, and
a demolding instruction to demold by separating the molds from each other in a state that the molded first and second moldings are supported on at least one of the molds;
the controller outputs, to the coating device:
a coating control instruction composed of a butting instruction to move the coating device so as to butt it against at least one of the demolded moldings,
a coating instruction to coat the butted molding, and
a separating instruction to separate the coating device from the coated molding and moving the coating device to the outside of the mold; and
the controller outputs, to the injection-molding device:
a second injecting control instruction composed of a second butting instruction to butt the first mold and the second mold against each other so that the coated molding and the other molding are butted against each other,
a second injecting instruction to bond the first and second moldings together, and
a demolding instruction to demold by separating the molds from each other.

28. An apparatus for producing a coated molded product comprising:
an injection-molding device including first and second molds that are constructed to move relative to each other so as to separate from and come into contact with each other in opposite directions of mold surfaces and move parallel to each other along the surface direction, and an injecting device that performs injection-molding;
a coating device that coats at least one of the moldings, and a moving device that moves the coating device; and
a controller to output operation control instructions to these injection-molding device and coating device, wherein
the controller outputs, to the injection-molding device and the coating device:
a first injecting instruction to injection-mold first and second moldings by butting mold surfaces for forming the first and second moldings formed on both molds, against each other;
a first demolding instruction to demold by separating the molds from each other in a state that the molded first and second moldings are supported on at least one of the molds;
a moving instruction to demold at least one of the supported moldings from the mold and moving the molding so as to be butted against the coating device;
a coating instruction to form coating on the butted molding to form a coated molding; and
a second injecting instruction to move the coated molding so as to be placed into the mold on the side facing the other molding, butting the first and second molds against each other so that the coated molding and the other molding butt against each other, and injection-molding for bonding the first and second moldings together.
